(19) United States
(12) Patent Application Publication
(10) Pub. No.: US 2026/0217482 A1
(43) Pub. Date: Jul. 30, 2026

(54) APPARATUS AND METHOD FOR THE ENERGY CELL PRODUCING INDUSTRY

(71) Applicant: KÖRBER TECHNOLOGIES GMBH, HAMBURG (DE)

(72) Inventor: Manfred FOLGER, Hamburg (DE)

(21) Appl. No.: 19/143,764

(22) PCT Filed: Dec. 14, 2023
(86) PCT No.: PCT/EP2023/085848

§ 371 Date: Jun. 26, 2025

(30) Foreign Application Priority Data
Jan. 11, 2023 (DE) 10 2023 100 483.2

(51) Int. Cl. B65G 57/03; B65G 47/91; H01M 10/04

(52) U.S. Cl. CPC B65G 57/03; B65G 47/917; H01M 10/0404

(57) ABSTRACT

Device for the energy cell manufacturing industry, comprising
a feed device which is adapted to feed segments, wherein
the device further comprises at least two production devices arranged parallel to one another in the production flow, which are each adapted to perform a production step on or with a fed segment, and
at least one discharge device which is adapted to discharge the segments from the production devices, wherein
the segments are transferred from the feed device to the production devices by means of a transfer device, and wherein
the device can be controlled and/or regulated by means of a control signal from a control device in such a way that a segment taken over from the feed device is transferred by the transfer device in a targeted manner to a specific production device of the at least two production devices.

The present invention relates to a device for the energy cell manufacturing industry with the features of the preamble of claim 1, as well as a method for performing a manufacturing step on or with segments for the energy cell manufacturing industry.

Energy cells or energy storage devices within the meaning of the invention are used, for example, in motor vehicles, other land vehicles, ships, aircraft or also in stationary installations such as photovoltaic installations in the form of battery cells or fuel cells, in which very large quantities of energy have to be stored over long periods of time. For this purpose, such energy cells comprise a structure of a plurality of segments stacked to form a stack. These segments are alternating anode sheets and cathode sheets, which are separated from each other by separator sheets also produced as segments. The segments are pre-cut during the manufacturing process and then stacked in the predetermined order and bonded together by lamination. The anode sheets and cathode sheets are first cut from a continuous web and then placed individually at intervals on a continuous web of a separator material. This subsequently formed “double-layered” continuous web made of the separator material with the applied anode sheets or cathode sheets is then cut again into segments in a second step using a cutting device, wherein the segments in this case are double-layered by a separator sheet with an anode sheet or cathode sheet arranged thereon. If this is feasible or necessary for manufacturing reasons, the continuous webs of separator material with the anode sheets and cathode sheets placed on top can also be placed on top of each other before cutting, so that a continuous web is formed with a first continuous layer of separator material with anode sheets or cathode sheets placed on top and a second continuous layer of separator material with anode sheets or cathode sheets placed on top of this. This “four-layer” continuous web is then cut into segments by means of a cutting device, which in this case are four-layered with a first separator sheet, an anode sheet, a second separator sheet, and a cathode sheet lying on top. The advantage of this solution is that one cut can be avoided. Segments within the meaning of this application are therefore, for example, single-layer segments of a separator material, anode material or cathode material, double-layer or even four-layer segments of the structure described above.

Devices for manufacturing battery cells are known, for example, from WO 2016/041713 A1 and DE 10 2017 216 213 A 1 .

Furthermore, a device for manufacturing an electrode stack is also known from WO 2019/048589 A1 . For this purpose, a transport system with sleds is provided on which electrode and separator layers can be stacked. There are stacking stations where only separator layers are deposited, stacking stations where only cathode layers are deposited, and stacking stations where only anode layers are deposited. In this way, a cell stack can be stacked in the desired sequence on the storage surface of the sled by moving the sled to the stacking stations in the appropriate sequence.

US 2002/0007552 A1 also discloses a device for manufacturing a battery cell. After a battery cell has been manufactured, it is transferred to a conveyor belt using the “pick and place” principle.

Today, battery cells, for example for electric mobility, are manufactured on production lines with a capacity of 100 to 240 mono cells per minute. These operate in substages or continuously with clocked discontinuous movements, such as back-and-forth movements, and are therefore limited in terms of production output. Most of the known machines operate in a single-sheet stacking process (e.g., “pick and place”) with the disadvantage of slower processing. Laminating cell formations is not possible here.

Another well-known approach is a machine with continuously running webs of material and clocked tools, such as cutting knives and tools for changing the spacing.

In principle, machines with clocked movements are limited in terms of performance. The parts with mass, such as holders and tools, must be permanently accelerated and decelerated. The processes determine the time sequences, and a lot of energy is consumed in the process. The mass of the moving parts cannot be reduced at will. Parts that move faster often have to withstand higher loads and are therefore even more complex and heavier.

In order to reduce the production costs of battery manufacturing, the production output of the machines must be increased, among other things. A prerequisite for high production output is a high production rate of the stacks of energy cells, which are formed from several segments of the type described above stacked on top of each other.

In an upstream manufacturing step, the segments are first stacked on top of each other to form so-called mono cells, consisting of a first separator sheet, an anode sheet arranged thereon, a second separator sheet arranged thereon, and a cathode sheet arranged thereon. In principle, however, a mono cell can also comprise the layer sequence: separator sheet—cathode sheet—separator sheet—anode sheet. Alternatively, the separator sheets can first be fed as two continuous webs, wherein the already cut segments in the form of anode sheets are then placed on one of the continuous webs and the already cut segments in the form of cathode sheets are placed on the other continuous web and bonded together by a lamination process. The composite webs prepared in this way are then joined together in a further lamination process to form a four-layer composite web.

It is also possible to place the first cut electrode in the form of the cathode or anode between the separator sheets in the form of continuous webs and to place the second cut electrode in the form of the anode or cathode on or under one of the separator sheets. The four-layer web is then laminated in a joint lamination process so that the mono cell is produced in a fixed formation while the continuous webs still exist, i.e. before cutting.

Regardless of whether the mono cells are produced using a one-stage or two-stage lamination process, the mono cells are then cut from the composite web by cutting through the spaces between the successive anode sheets or cathode sheets.

Alternatively, the continuous webs made of the separator material with the anode sheets and cathode sheets arranged thereon can also be cut first, wherein the mono cells are then produced by a downstream composite process of a first cut separator sheet with an anode with a second cut separator sheet with a cathode.

The segments are then stacked on top of each other to form a stack of a plurality of segments. If the segments are mono cells or separator sheets with anode or cathode sheets arranged thereon, a cathode or anode is located on a free side surface of the stack, for example, which is then covered by the arrangement of a so-called end cell. In this case, the end cell comprises a first separator sheet, an anode or cathode sheet arranged thereon, and a second separator sheet arranged thereon, on which, however, no cathode or anode sheet is arranged. The end cell can thus also be regarded as a mono cell without a cathode or anode sheet. However, other designs of the end cell are also possible.

When processing segments, for example when forming cell stacks from segments, delays in the provision of segments may occur for various reasons.

The object of the present application is to provide an improved device and a corresponding method for performing a manufacturing step on or with a supplied segment, with which the delays in the provision of segments can be compensated.

Some terms used in this application will first be explained.

For the purposes of this application, production devices arranged parallel to each other in the production flow are understood to mean that the production devices are arranged in such a way that each of the production devices can be supplied with a segment without the interposition of another production facility. The production devices are thus supplied with segments via different conveyor paths. If, for example, four production devices are provided, then a first production facility is supplied with segments via a first conveyor path, a second production facility via a second conveyor path, a third production facility via a third conveyor path, and a fourth production facility via a fourth conveyor path. In contrast, if the production devices were arranged in series in the production flow, the segments would pass through the production devices one after the other.

In the sense of this application, a production flow refers to the movement of the segments, but also, for example, their starting products, starting materials, and the intermediate and/or end products formed by the segments within the device. The production flow is determined by conveyor paths.

In the sense of this application, a production device is understood to be a device with which a segment can be processed or worked on. Thus, value is added by the production device. Consequently, for example, an ejection station with which individual segments can be removed from the production flow is not a production device within the meaning of this application.

According to a first aspect of this application, a device for the energy cell manufacturing industry is proposed to solve the problem, comprising a feed device which is adapted to feed segments, wherein the device further comprises at least two production devices arranged parallel to each other in the production flow, each of which is adapted to perform a production step on or with a fed segment, and at least one discharge device which is adapted to remove the segments from the production devices, wherein the segments are transferred from the feed device to the production devices by means of a transfer device, and wherein the device can be controlled and/or regulated by means of a control signal from a control device in such a way that a segment taken over from the feed device is transferred by the transfer device in a targeted manner to a specific production device of the at least two production devices.

The targeted feeding of the segments to one of the production devices requires that the transfer device can be switched accordingly. Only in this way can the segment taken over by the feed device be fed to a production device specified by the control device. This prevents the segments taken up from being assigned to the production devices in a purely random manner.

The production station to which the segment is specifically fed can change depending on various conditions, for example, due to the occurrence of a specific event or depending on the time. In the following, the production device determined by the control device to which the segment is fed by the transfer device is referred to as the target production device.

The transfer device defines a conveyor path for the segment starting from the feed device and ending at the target production devices. In this way, the supply to the production devices can be controlled in a targeted manner, even if, for example, irregularities occur in the provision of segments.

Preferably, each of the production devices is assigned a unique identifier, for example in the form of a number and/or letter code. By using this identifier, the target production device can be uniquely determined and identified by the control device. The identifier can, for example, be stored on a storage medium of the control device.

A processor of the control device preferably calculates a corresponding control signal in order to control and/or regulate the transfer device in such a way that the segment taken over by the feed device is transferred to the target production device. In this way, it can be ensured that the desired production device is supplied with the respective segment.

The segments are preferably the mono cells mentioned at the beginning, so that the production devices can, for example, perform a production step for producing energy storage devices. In principle, the device can be adapted to perform a production step on or with segments of a different type. Particularly suitable are multi-layer segments for energy cells, which can be used, for example, to manufacture fuel cells or solid-state batteries.

Preferably, the device can be controlled and/or regulated by the control signal from the control device in such a way that a segment taken over by the feed device can be transferred to any production device of the existing production devices. In other words, the control device can define each of the existing production devices as the target production device for each individual segment taken over by the feed device. Furthermore, the device is then also physically adapted to implement the corresponding control signals of the control device. This means that the segment can also be transferred to the currently selected target production device completely independently of the time at which the segment is provided by the feed device. Furthermore, all existing production devices can be used to parallelize the production process. Parallelization increases the time available for performing a production step at the production stations. This enables production steps that were previously not possible due to the production speed, or production steps can be performed with higher quality.

Preferably, the feed device comprises a single conveyor path for the segments, on which the segments are fed to the transfer device. The transfer device thus not only performs a distribution function, so that the segments are transferred specifically to the selected target production device. In addition, the transfer device is able to split the single conveyor path for the purpose of parallelization. The conveyor paths leading to the at least two production devices and defined by the transfer device may also overlap in sections.

Furthermore, a single discharge device is preferably provided to take the segments from the production device. This is adapted, for example, to recombine the products or intermediate products produced by the production devices, for example a stack formed by segments, into a single conveyor path. By means of the discharge device, the products or intermediate products can then be fed to a device for carrying out a downstream production step.

It is further proposed that the production devices are each formed by a stacking station, wherein the stacking stations are each adapted to receive segments and to stack them on top of each other. A stack is thus formed at each production device. If, for example, segments in the form of the mono cells described above are used, the production devices can each form stacks of cells which can be used as energy storage devices.

Preferably, the control device can control and/or regulate the device in such a way that alternately exactly one of the at least two production devices is the target for a segment. In this way, the production devices can be supplied with segments in a predefined sequence, for example. For example, the production devices can be supplied with one segment at a time in succession; furthermore, this process can be repeated as often as desired. The proposed device thus advantageously makes it possible to compensate for any missing segments during provision by the feed device in such a way that the sequence of supply to the stacking stations is not impaired. Segments may be missing during feeding for various reasons, for example because they are removed for quality inspection. Furthermore, by changing the target production device in a predetermined sequence, it can be ensured that the products or intermediate products formed in parallel by the multiple production devices, for example the cell stacks, can be transferred to the subsequent at least one discharge device at a desired cycle rate.

It is further proposed that the control device controls and/or regulates the device in such a way that the existing production devices are supplied alternately with a predefined number of segments, preferably with exactly one segment. This allows the segments to be distributed evenly among the production devices.

It is further proposed that the device is controlled and/or regulated by means of the control device in such a way that the production devices are supplied with segments in several passes, wherein in one pass each of the existing production devices is supplied with exactly one segment.

If, for example, exactly four production devices are provided, then the supply of one segment at a time within a pass takes place, for example, in the following order: first production device, second production device, third production device, fourth production device. The control device can be adapted to arrange any number of passes immediately after one another.

If the production devices are stacking stations, the stacks of segments can be formed, for example, in such a way that in each production station the last segment of the respective stacks is placed within a stacking pass. This ensures that the stacks are completed at approximately the same time. With the last segment of the stack, the stack reaches a predefined stack height, which can be determined by means of the control device. The predefined stack height thus indicates the number of segments, preferably more than two segments, required to form a finished stack. If cell stacks are formed by means of the stacking stations, the stack can be supplemented with the final cell mentioned above or with an anode sheet with or without a separator sheet after the predefined stack height has been reached in order to form a finished cell stack.

Alternatively, the stacks may initially comprise different heights, so that passing through the cycles spreads over time the completion of the stacks, i.e., reaching the predefined stack height, in the individual production devices. In this variant, for example, if there are four production devices, the first production device may comprise a finished stack, a second production device may comprise a stack that is ¾ finished, a third production device may comprise a stack that is ½ finished, and a fourth production device may comprise a stack that is ¼ finished.

Preferably, the stack is then transferred from the production device to the at least one discharge device when the corresponding production device has been supplied with segments by means of a predefined number of passes. In the following pass, a new stack is then started at the respective production device.

It is further proposed that the transfer device comprises at least one dispensing transport unit with at least one holding device for exerting a holding force on the segment in the production flow, wherein the production devices each comprise a receiving transport unit with at least one holding device for exerting a holding force on the segment in the production flow, wherein a specific transfer of a segment to one of the production devices takes place by setting the holding forces on the dispensing and/or receiving transport unit by means of a control signal generated by the control device. Preferably, a switchable switching device is provided for reducing or cancelling the holding force as a result of a signal from the control device. The segments can be transferred specifically to one of the production devices by means of the switchability of the holding device of the dispensing and/or receiving transport unit.

It has also proven advantageous if the dispensing and receiving transport units each comprise at least one rotatably driven rotary body, preferably in the form of a dispensing drum, wherein the dispensing and receiving transport units each comprise at least one negative pressure sector that can be subjected to negative pressure in order to hold and transport a segment on a transport surface of the respective transport unit by means of negative pressure, wherein the device can be controlled and/or regulated in such a way that, as a result of a control signal from the control device for transferring the segment, a higher holding force is generated on the receiving transport unit relative to the dispensing transport unit at least in a transfer area between the dispensing and receiving transport units. The negative pressure sectors can thus be regarded as holding devices for the segments. The force acting on the transport surface or on a partial area of the transport surface by means of negative pressure thus changes temporarily. In this way, reliable and product-friendly transfer of the segments to the production devices can be ensured.

Preferably, the transfer device comprises two dispensing transport units, each formed by a transfer drum and comprising corresponding holding devices, so that the segments can be transported, for example, on their outer surface, which forms the transport surface, along a section of a circular path. Preferably, a first dispensing transport unit is supplied with segments by the feed device. If corresponding segments are not transferred from the first transferring transport unit to one or more of the production devices assigned to it, they are preferably transferred by means of a diverting drum, which also comprises holding devices, to a second transferring transport unit in the form of a transfer drum, from which the remaining segments are transferred to one or more production devices which are assigned to the second dispensing transport unit. For example, the first dispensing transport unit can supply a first and a second production device, for example formed by stacking stations, with segments, while a second dispensing transport unit supplies a third and a fourth production device, which are also formed by stacking stations, with segments. In this way, the production flow can comprise four conveyor paths, wherein each conveyor path leads to one of the production devices.

It has also been shown that the segments can be held in a product-friendly manner on a transport surface of the rotary bodies, for example on their outer surface, by the negative pressure.

If the production devices are formed by stacking stations, it is proposed that the stacking stations each comprise a receiving transport unit which takes over the segments at a conveying speed from one of the dispensing transport units in a transfer area and then deposits them to form a stack. If the transfer device comprises the aforementioned rotary bodies and the segments are held on their outer surface, then the conveying speed corresponds to the circumferential speed of these rotary bodies. Preferably, the segment is deposited to form the cell stack at a transfer point at a speed that is lower than the conveying speed, and more preferably at a speed of zero. Consequently, the receiving transport unit is preferably adapted to reduce its speed starting from the transfer area, at which the segment is taken over from the transfer device, to a transfer point, at which the segments are stacked. In principle, it is also conceivable that the speed of the segment is increased temporarily between the point at which the segment is picked up and the point at which it is deposited to form the stack.

According to a preferred embodiment, it is proposed that the stacking stations each comprise at least one magazine into which the receiving transport unit places the segments on top of each other to form the stack. The magazine is accordingly arranged at the transfer point where the segments are placed on top of each other to form a cell stack. The magazine can, for example, be part of a magazine drum, so that the corresponding magazine can be rotated after the stack has been formed and can be made available in a pick-up area of the discharge device by the rotational movement of the magazine drum.

It is further proposed that, in order to reduce the holding force in a section of the transport surface of the dispensing transport unit, at least one valve switchable in a negative pressure device is arranged, wherein the at least one switchable valve can be switched by means of a control signal from the control device in such a way that the holding force acting on a segment on the transport surface of the dispensing transport unit is reduced. In this way, the areas on the respective transport surface where the segments are to be held by a holding force can be easily subjected to negative pressure. If the dispensing transport unit comprises several negative pressure sectors, the holding force can, for example, be reduced specifically for one negative pressure sector.

It is further proposed that a compressed air device, switchable for example by means of a valve, is provided for conducting compressed air to a dispensing point of the dispensing transport unit and/or to a receiving point of the receiving transport unit, wherein the compressed air device is switchable by means of a control signal from the control device. By using compressed air at the dispensing point, a dispensing force can be exerted on the segment, thereby improving the transfer of the segment from the transfer device to the respective target stacking station. It is crucial in this case that the pressure force acts in the direction of the receiving transport unit.

There are various possibilities for ensuring that the holding force of the dispensing transport unit in the transfer area is lower than the holding force of the receiving transport unit of the corresponding production device:

Firstly, in the transfer area, the holding force acting on the segment due to negative pressure on the dispensing transport unit of the transfer device can be temporarily reduced or eliminated in comparison to the receiving transport unit of the production device. The negative pressure level for generating the holding force of the receiving transport unit can then remain constant.

Secondly, in the transfer area, the holding force acting on the segment by negative pressure on the receiving transport unit of the respective production device can be higher or temporarily increased compared to the dispensing transport unit of the transfer device. The negative pressure level for generating the holding force of the dispensing transport unit can then remain constant.

Thirdly, the segment to be dispensed, which is held by negative pressure on a transport surface of the dispensing transport unit, can be temporarily subjected to compressed air with a force acting in the direction of the stacking station. If the holding device of the dispensing transport unit is still active in this situation, the holding force exerted by the dispensing transport unit on the segment in the transfer area is lower than the pressure force exerted by the compressed air in the direction of the dispensing transport unit.

Preferably, the existing production devices have an identical structure and/or are adapted to perform an identical production step on or with a segment. This allows redundancy to be created, thereby increasing the system reliability of the device.

Preferably, an ejection station is provided which is adapted to eject segments from the production flow. Such an ejection station may, for example, comprise an ejection drum with which the segments can be ejected into a reject reservoir. Preferably, the ejection station is adapted to remove a segment from the product flow in response to a switching signal.

The ejection station can be located upstream of the transfer device in the production flow. Preferably, the data generated by the ejection station is provided to the control device. The control device can use this data to control and/or regulate the transfer device. Furthermore, the transfer device can also be controlled and/or regulated on the basis of this data.

Alternatively or additionally, the ejection station can also be arranged downstream in the production flow of the transfer device so that the ejection station is supplied with segments by means of appropriate control and/or regulation of the transfer device. These segments are then not fed to the production devices. Like the production devices, the ejection station can also be arranged in the production flow parallel to the existing production devices. The transfer device is then adapted to transfer the segment either to one of the production devices or to the ejection station, depending on the control signal from the control device.

For example, segments can be ejected from the production flow if a test has shown that they do not meet the quality requirements. It is also possible to eject segments from the production flow in order to use them as samples for quality control.

Preferably, the feed device comprises several segment holders which are adapted to transport one segment each, wherein a detection device is provided which is adapted to detect unoccupied segment holders of the feed device, wherein data determined by the detection device are provided to the control device for controlling and/or regulating the transfer device. The detection device may comprise, for example, an optical measuring instrument, for example in the form of a camera. However, other embodiments of the detection device are also conceivable. The data transmitted to the control device in this way enables the transfer station to always take over the next incoming segment from the feed device in a targeted manner and transfer it to the respective target conveyor device.

According to a second aspect of this application, a method for performing a manufacturing step on or with a segment for the energy cell manufacturing industry is proposed, wherein the method is carried out using the device according to any one of the preceding claims. With regard to the technical effects and advantages associated with the proposed method, reference is made to the preceding statements in connection with the device.

In the event that the production devices are each formed by a stacking station, it is proposed that segments in the form of mono cells are stacked on top of each other in the production devices, wherein the mono cells each comprise two separator sheets, an anode sheet and a cathode sheet.

It is further proposed that a first type of segments in the form of mono cells is fed by means of the feed device and that a second type of segments, which differs from the first type of segments, is additionally fed by means of the feed device, wherein a segment of the second type taken over by the feed device is specifically transferred by the transfer device to a specific production device of the at least two production devices, that the segment of the second type forms the first or last layer of the stack of segments formed by the respective production device. Thus, a pre- and/or post-placement function for a completion cell can be realized by means of the production devices. Thus, the completion of an energy cell by means of the production devices can be effected by a segment of the second type, for example in the form of a single anode sheet with or without a separator sheet, in the form of the completion cell mentioned at the beginning, or in the form of an insulating and/or protective sheet which protects the stack at the front from external mechanical influences. Alternatively, or additionally, the second type of segment may also comprise a wrapping material. Such a wrapping material is preferably dimensioned such that it can partially or completely surround, in particular wrap around, the rest of the stack, so that the segments of the respective stack can be fixed in place. Additional devices for placing or adding a corresponding completion to the stack are thus unnecessary. The second type of segment can then be fed to the transfer device by means of the feed device or by means of a separate feed device.

The invention is explained below with reference to preferred embodiments and with reference to the accompanying figures. These show:

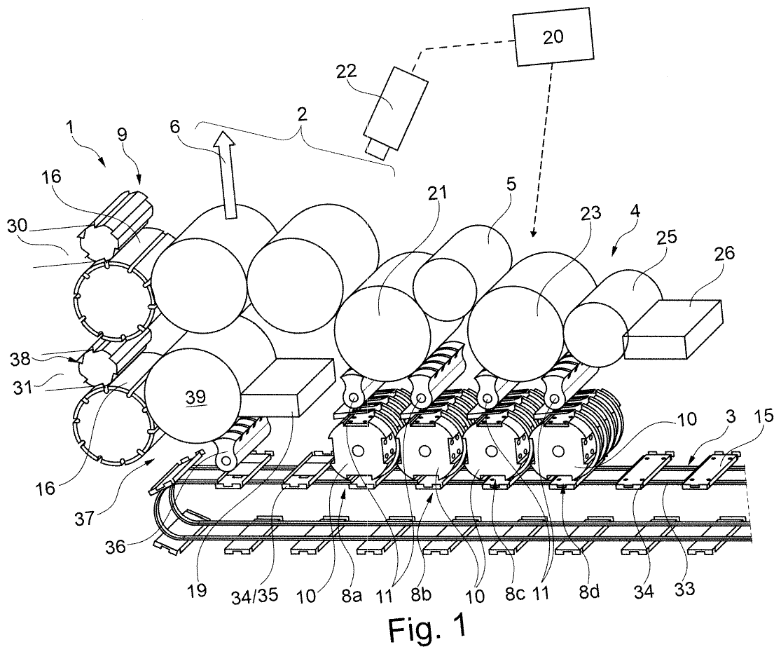

FIG. 1 a device with four production devices;

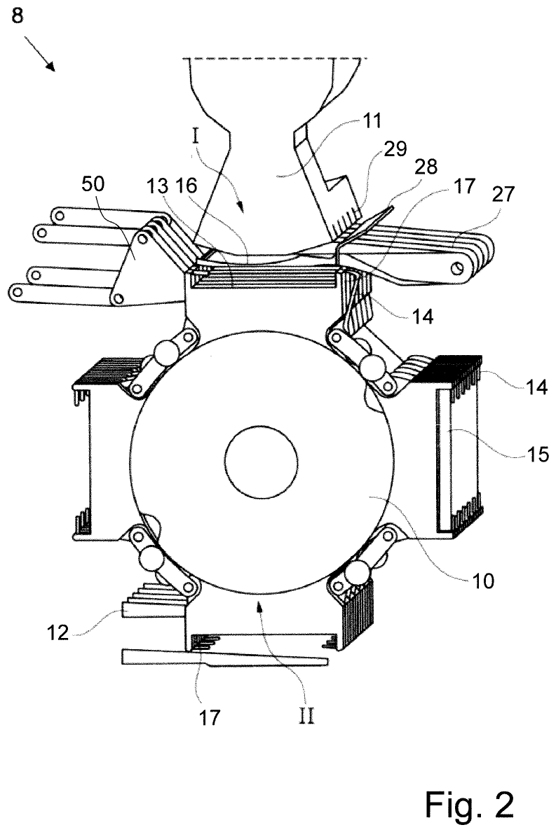

FIG. 2 a production device in the form of a stacking station; and

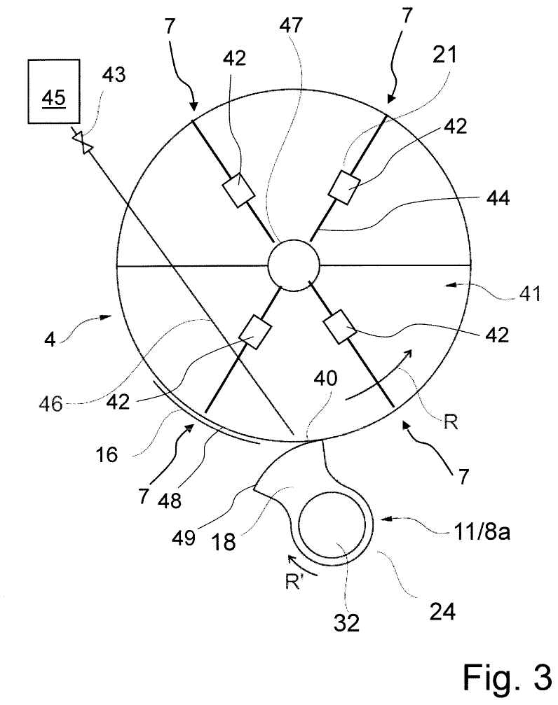

FIG. 3 a schematic representation of a dispensing transport unit of a transfer device and a receiving transport unit of a production device.

FIG. 1 shows a device 1 for forming stacks 15 from segments 16 for the energy cell manufacturing industry. The device 1 comprises a feed device 2, a discharge device 3, an upstream cutting device 9 and four production devices 8a-8d arranged in a production flow between the feed device 2 and the discharge device 3. The production devices 8a-8d are arranged parallel to each other in the production flow so that they can be supplied with segments 16 directly by a transfer device 4, i.e. without intermediate holding by another production device 8a-8d. In principle, however, more or less than four production devices 8a-8d are also conceivable. In this embodiment, the four production devices 8a-8d are formed by stacking stations, each of which is adapted to receive segments 16 and stack them on top of each other to form a stack 15. In this embodiment, the segments 16 are formed by the mono cells described at the beginning, so that stacks 15 in the form of cell stacks are formed by means of the production devices 8a-8d.

The feed device 2 feeds the segments 16 to the transfer device 4 to form stacks 15, which receives them and transfers them to the production devices 8a-8d.

An continuous web 30 comprising two continuous webs of a separator material with anode sheets arranged therebetween and spaced apart in the longitudinal direction of the continuous web 30 and cathode sheets also spaced apart in the longitudinal direction of the continuous web 30 and arranged on one side of one of the continuous webs of the separator material is fed to the device 1. However, the continuous web 30 can also be formed from only one continuous web of a separator material with or without adjacent electrode sheets. If the continuous web 30 comprises spaced electrode sheets, the cutting in the cutting device 9 is carried out in each case through the separation points between the electrode sheets.

The cutting device 9 is formed here by a pair of drums consisting of a cutting drum with cutting blades and a counter drum with counter blades and cuts the continuous web 30 guided on the cutting drum or the counter drum into segments 16 of a predetermined length by shearing the cutting blades against the counter blades, which is defined by the distances between the cutting blades or the counter blades, depending on whether the continuous web 30 is guided on the cutting drum or the counter drum. Alternatively, the cutting device 9 can be adapted to cut the continuous web 30 into segments 16 of a predetermined length by thermal cutting. Starting from the cutting device 9, the cut segments 16 are fed to the feed device 2. The feed device 2 comprises several transport drums on which the segments 16 are held, for example by negative pressure, until they are finally transferred to a first dispensing transport unit 21 in the form of a transfer drum of the transfer device 4.

The continuous web 30 fed in is a four-layer web, so that the segments 16 cut from it correspond to the mono cells described above, which can be used to form energy storage devices.

Furthermore, the feed device 2 comprises an ejection station 6, shown only schematically, with which defective segments 16 can be detected and ejected from the production process.

The four production devices 8a-8d each comprise a receiving transport unit 11 in the form of a discharge pusher driven to perform a rotary movement. The transfer device 4 comprises the first dispensing transport unit 21 already mentioned in the form of a transfer drum and a second dispensing transport unit 23 also in the form of a transfer drum. Two of the receiving transport units 11 are assigned to the first dispensing transport unit 21; during their circular movement, they remove segments 16 from the dispensing transport unit 21 and then transfer them to a magazine drum 10, which will be explained in more detail in FIG. 2.

The transfer device 4 is controlled and/or regulated by means of a control device 20 in such a way that each segment 16 taken over by the feed device 2 can be fed specifically to one of the four production devices 8a, 8b, 8c or 8d. For this purpose, one of the production devices 8a, 8b, 8c or 8d is specified as the target production device by means of the control device 20. In this embodiment, the production devices 8a-8d are each assigned a unique station ID. Production device 8a is characterized by station ID S 1; production devices 8b by S 2; production device 8c by S 3; and production device 8d by S 4.

In this embodiment, the segments 16 are to be distributed one after the other to the production devices 8a, 8b, 8c, and 8d so that the respective stacks 15 are always completed in the same order.

The control device 20 thus initially defines the production device 8a as the target production device by means of the station ID S1. A segment 16 transferred from the feed device 2 to the transfer device 4 is transferred from the first dispensing transport unit 21 to the stacking station 8a.

The production device 8a is followed as the target production device by the production device 8b, which is characterized by the station ID S2. A segment 16 transferred from the feed device 2 to the transfer device 4 is transferred by the first dispensing transport unit 21 to the production device 8b.

The production device 8b is followed by the production device 8c, which is characterized by the station ID S3, as the target production device. A segment 16 transferred from the feed device 2 to the transfer device 4 is transferred by the first dispensing transport unit 21 to the rotary body 5 in the form of a diverting drum and from there in turn to the second dispensing transport unit 23; the rotary body 5 and the second dispensing transport unit 23 are components of the transfer device 4. In the process, the segments 16 are turned over twice in their orientation with respect to their surfaces during transfer from the first dispensing transport unit 21 and transfer from the rotary body 5 to the second dispensing transport unit 23, so that the segments 16 are then arranged on the second dispensing transport unit 23 in an identical orientation to that on the first dispensing transport unit 21. Two receiving transport units 11 in the form of rotating discharge pushers are assigned to the second dispensing transport unit 23, which take the segments 16 from the second dispensing transport unit 23 and feed them to a magazine drum 10 according to the same principle. From the second dispensing transport unit 23, the segment 16 can then be transferred to the production device 8c.

The production device 8c is followed by the production device 8d, which is characterized by the station ID S4, as the target production device. In this case, the segment 16 is transferred from the feed device 2 via the first dispensing transport unit 21, the rotary body 5 and the second dispensing transport unit 23 to the production device 8d.

The sequential supply of production devices 8a, 8b, 8c, and 8d with one segment 16 each is referred to as a pass, which can be repeated as often as desired until a predefined stack height is reached.

As soon as a stack 15 has been completed at one of the production devices 8a-8d, i.e. a predefined number of segments 16 have been stacked on top of each other, the respective magazine drum 10 can be rotated so that the stack 15 can be transferred to the discharge device 3.

The control device 20 is adapted to control the transfer device 4 and the receiving transport units 11 in such a way that the sequence of the target production devices described above can be maintained even if the feed device 2 does not continuously feed segments 16, i.e. if a segment holder of the feed device 2 remains empty. In order to detect when a segment holder of the feed device 2 is empty, a detection device 22 is provided which is connected to the control device 20 by means of signals. In the case of a non-switchable transfer device 4, the absence of a segment 16 would result in one or more of the production devices 8a, 8b, 8c or 8d being skipped when a segment 16 is supplied. The proposed device 1 prevents this by means of appropriate control or regulation.

Furthermore, the device 1 comprises a test device (not shown) which is adapted to detect defective segments 16. The defective segments 16 are then not removed by the receiving transport units 11 from the two dispensing transport units 21 and 23 and are instead discharged via an ejection drum 25 into a reject reservoir 26. The supply of a defective segment 16 to the ejection drum 25 is also controlled by corresponding control signals from the control device 20. In this case, the reject reservoir 26 is located downstream of the transfer device 4 in the production flow.

The segments 16 are fed in an inflow by the feed device 2 and transferred to the four production devices 8a-8d for parallel stacking. For this purpose, the segments 16 are dispensed by the four receiving transport units 11 into four parallel magazine drums 10 of the production devices 8a-8d, in which the segments 16 are stacked on top of each other to form stacks 15 and are then dispensed to the discharge device 3.

The four production devices 8a-8d each comprise, as core components, a receiving transport unit 11, a magazine drum 10 and a dispensing device 12, wherein one of the production devices 8a-8d is shown enlarged in FIG. 2.

FIG. 2 shows that the receiving transport unit 11 of a production device 8 is formed by a discharge pusher driven in a rotary movement, which during each rotational movement takes a segment 16 from one of the two dispensing transport units 21 or 23 (see FIG. 1) and moves it to a transfer point I of the magazine drum 10. The magazine drum 10 comprises four magazines 13 arranged on its outer circumference, which are open towards the outer sides. Furthermore, a scraping device movable relative to the magazine drum 10 and in relation to the transfer point I is provided in the form of a comb-like scraping part 27 with a plurality of scraping webs arranged parallel to one another, which engages with the scraping webs through corresponding slots in a likewise fixed scraping wall 28. The scraping part 27 is thus to be understood as an active deflector which removes the segment 16 from the transport unit 11 and places it on the top of a stack 15 to be formed in the magazine 13.

Furthermore, a parallel guide 50 is provided, which does not rotate with the magazine drum 10 and forms a height-adjustable base for the stack 15 to be formed at the transfer point I. The parallel guide 50 moves the stack base of the unfinished stack 15 downwards during stacking in order to keep the top edge of the stack in the magazine at a constant height for the addition of further segments 16. For this purpose, the parallel guide 50 comprises struts arranged parallel to one another, which can engage in corresponding recesses of the magazine 13 when the latter is located at the transfer point I.

Furthermore, the discharge pusher comprises slots 29 which are parallel to each other and directed in the circumferential direction of the discharge pusher's rotary movement, into which the scraping part 27 engages with its scraping webs during the rotary movement of the discharge pusher, whereby the segment 16 held on the outside of the discharge pusher is scraped off into the magazine 13 arranged in the transfer point I during the rotary movement of the discharge pusher. Since the transfer point I in the present embodiment is arranged on the upper side of the magazine drum 10 and the segments 16 are inserted into the magazine 13 from above, the insertion movement of the segments 16 into the magazines 13 is additionally supported by the acting force of gravity in this case; however, the segments 16 are deposited in the respective magazine 13 primarily by the active scraping part 27.

Furthermore, the magazine 13 comprises comb-like side walls with engagement openings 17 aligned in the circumferential direction and a holding device 14 in the form of a plurality of engagement fingers which can be pivoted by means of a pivoting mechanism. The movement of the holding device 14 of the magazine 13, i.e. the pivotable engagement fingers, is controlled by the control device 20 in such a way that the engagement fingers of the holding device 14 do not engage in the engagement openings 17 at the transfer point I and thus leave the opening of the magazine 13 free to the outside. This means that the opening of the magazine 13 at the transfer point I is freely accessible and the segments 16 can be stacked therein to form a stack 15 at a predefined height by a repetitive circular movement of the dispensing transport unit 21.

When the predetermined height of the stack 15 in the magazine 13 is reached, the magazine drum 10 is rotated by 90 degrees and the next magazine 13 is moved to the transfer point I to repeat the stacking process. At the same time, when the magazine drum 10 begins to rotate, the holding device 14 is moved by the control device 20 (see FIG. 1) so that its engagement fingers engage through the engagement openings 17 in the side walls of the magazine 13 and come to bear against the top of the stack 15. The holding device 14 then secures the stack 15 against unintentional release from the magazine 13.

During the subsequent cycle of the rotary movement of the magazine drum 10, the magazine 13 filled with the stack 15 moves to the transfer point Il shown at the bottom of the figure. At the second transfer point Il, the stationary dispensing device 12 is provided in the form of several sections arranged parallel to each other and aligned with the engagement openings 17, which, during the rotary movement of the magazine drum 10, engage in the engagement openings 17 at the level of the bottom of the magazine 13 and thereby comb the stack 15 out of the magazine 13. Since the stacks 15 are discharged downwards from the magazine 13, the discharge movement is again assisted by gravity. In a previous step, the holding device 14 was released to allow the stack 15 to be discharged.

This can be done, for example, by the dispensing device 12 actuating the holding device 14 before or simultaneously with the movement of its webs into the engagement opening 17 and moving it into a release position in which the holding device 14 releases the opening of the magazine 13 and the stack 15 can be discharged from the magazine 13. The dispensing device 12 is formed here by a structure of fixed webs which combs the stacks 15 out of the magazines 13. If such active combing is not necessary, it is also sufficient for the dispensing device 12 to simply actuate the holding device 14 and allow the stacks 15 to fall out of the magazines 13 under their own weight. In this case, the dispensing device 12 would be a passive dispensing device 12, which triggers the discharge of the stacks 15 but does not actively support it.

As an alternative to the passive discharge device 12, a pusher in the magazine drum 10 and a pick-up device below the transfer point II could also be provided. In such a case, depending on the design, the transfer of the stack 15 from the magazine 13 could additionally be supported by gravity.

The discharge device 3 shown in FIG. 1 comprises a continuous conveyor device 33, such as a continuous band, a continuous chain, a continuous belt or the like. The continuous conveyor device 33 is equipped with a plurality of workpiece carriers 34, which comprise a holder 35 shaped to correspond to the shape of the stacks 15. The workpiece carriers 34 are aligned and held on the continuous conveyor device 33 in such a way that they are arranged in the transfer point II (see FIG. 2) under the magazine 13 so that the stack 15 is discharged from the magazine 13 into a holder 35 of the workpiece carrier 34. The discharge device 3 performs a clocked feed movement while the workpiece carriers 34 are transported either from one of the production devices 8a, 8b, 8c, 8d to the next or in jumps over several stacking stations 8a, 8b, 8c, 8d.

A second feed device 37 with a second cutting device 38 and a removal device 36 is also provided. The second feed device 37 is also supplied with a continuous web 31 either in a single layer made of a separator material or in multiple layers, e.g. three layers with several webs of a separator material and electrode sheets arranged therebetween, wherein no electrode sheets are provided on the outer sides of this continuous web. This continuous web is cut in the second cutting device 38 according to the same principle as the first cutting device 9 into segments 16 (in this case, these are the end cells described at the beginning) of a predetermined length, which are then transferred to a rotary body 39 in the form of a transfer drum, from which the segments 16 are removed by the second removal device 36 and inserted into the holders 35 of the workpiece carriers 34 before the stacks 15 are introduced from the magazine drums 10 into the holders 35.

The stacks 15 inserted by the magazine drums 10 comprise a free electrode sheet on one of their surfaces. This free electrode sheet is now covered by the segment 16 inserted via the second removal device 36, the completion cell. Since the segment 16 inserted by the second removal device 36 deliberately does not comprise a free electrode sheet, but instead comprises a separator material on both surfaces, the stack 15 of segments 16 finally discharged by the discharge device 3 also comprises a separator material on both sides.

In the embodiment described, the second removal device 36 inserts the segments 16 into the holders 35 of the workpiece carriers 34 before the stacks 15 are introduced. However, it is also conceivable that the second removal device 36 places the segments 16 on top of the cell stacks 15 from above after the cell stacks 15 have been inserted into the holders 35.

Alternatively, it is also possible to close the stack 15 with segments 16 that differ from the mono cells by making use of the switchability of the transfer device 4. In this case, the segments 16 that differ from the mono cells, i.e., for example, the completion cell mentioned at the beginning, or a single anode sheet with or without an electrode sheet, can be fed by means of the second feed device 37 to the transfer device 4, where it is then fed, for example, as the first segment 16 of a stack 15 to be formed to one of the production devices 8a, 8b, 8c or 8d. The transfer device 4 can then supply the corresponding production device 8a, 8b, 8c or 8d with segments 16 until the cell stack 15 has reached the predefined height, i.e. is complete.

Furthermore, a corresponding, not shown testing device is provided in the second feed device 37, by means of which defective segments 16 are detected and discharged into a second reject reservoir 19.

FIG. 3 below illustrates how the transfer device 4 and the receiving transport unit 11 of the stacking station 8a are controlled by the control device 20 (see FIG. 1).

It can be seen that the dispensing transport unit 21 comprises several negative pressure sectors 7 which, depending on the position of the valves 42, can be subjected to negative pressure by means of a vacuum reservoir 47. In this way, segments 16 can be subjected to a holding force on a transport surface 48, which is formed here by a surface of the rotary body, by the effect of the negative pressure and thus be held and transported. The negative pressure sectors 7 therefore form a holding device for exerting a holding force on the segments 16.

FIG. 3 shows the dispensing transport unit 21 in the form of the transfer drum as a component of the transfer device 4. The receiving transport unit 11 is arranged in a transfer area 40 tangential to the dispensing transport unit 21. The receiving transport unit 11 is designed as a segment drum and comprises a negative pressure sector 18 in a circumferential section, for example in the form of a cam extending, for example, by approximately 50°, and a negative pressure-free sector 24 in a second circumferential section extending, for example, by the remaining 310°. The negative pressure sector 18 is supplied with negative pressure via a central vacuum reservoir 32.

In principle, the drums are only subjected to a vacuum in partial areas of their circumference.

In a first position, which is not shown in FIG. 3, the rotational position of the receiving transport unit 11 is set so that the negative pressure sector 18 is turned away from the dispensing transport unit 21 and is therefore not in operative connection with the rotary body 21. In this position, the negative pressure-free sector 24 is thus located in a transfer area 40 of the dispensing and receiving transport units 21 and 11. The receiving transport unit 11 is thus switched to be non-functional and the segments 16 held on the dispensing transport unit 21 and passing through the transfer area 40 are further transported on the rotary body 21 in rotation direction R, for example to the 3 o'clock position.

To divert segments 16 to the receiving transport unit 11 of the stacking station 8a, the negative pressure sector 18 of the receiving transport unit 11 is pivoted in the direction of rotation R′ into the transfer area 40; this position is shown in FIG. 3. As soon as the negative pressure sector 18 is tangential to the dispensing transport unit 21, a valve 43 is opened by the control device 20 (see FIG. 1) and the transfer area 40 is supplied with compressed air via the compressed air line 46, which is supplied with compressed air via a compressed air line device 45, in order to break the negative pressure generated by a negative pressure device 41. Since the dispensing transport unit 21 no longer exerts any holding force on the segment 16 located in the transfer area 40, it is sucked by the negative pressure sector 18 of the receiving transport unit 11 and taken over, so that the segment 16 can be transported further on a transport surface 49 of the receiving transport unit 11. By further pivoting the receiving transport unit 11 and thus also the negative pressure sector 18, the segment 16 is further conveyed and can, for example, be transferred to the rotary body 5 downstream of the receiving transport unit 11 or to the production device 8b (see FIG. 1), which are not shown in FIG. 3 for the sake of clarity.

In FIG. 3, the negative pressure of the dispensing transport unit 21 for dispensing a segment 16 to the removal device 11 is broken or neutralized by means of compressed air. In general, the negative pressure of the dispensing transport unit 21 does not need to be reduced to zero in order to dispense a segment 16. For the transfer, it is generally sufficient if the negative pressure of the receiving transport unit 11 exerts a stronger holding force on the segment 16 than the dispensing transport unit 21.

Alternatively or in addition to applying compressed air to the transport surface 48 of the dispensing transport unit 21 in the transfer area 40, vacuum lines 44 connecting the vacuum reservoir 47 to the vacuum sectors 7 of the dispensing transport unit 21 can also be deactivated by means of the valves 42, so that the segments 16 are no longer held by the negative pressure on the outer surface of the dispensing transport unit 21. The valves 42 are then also controlled by means of the control device 20.

Alternatively or additionally, it would also be possible to apply a negative pressure to the negative pressure sector 18 of the receiving transport unit 11 in the transfer area 40 which exerts a greater holding force on the segment 16 than the negative pressure sector 7 of the dispensing transport unit 21.

It goes without saying that this principle of transfer can also be applied to further transfers of the segments 16; in particular for a transfer of the segments 16 from the dispensing transport unit 21 to the second production device 8b; for transfer from the first dispensing transport unit 21 to the rotary body 5; for transfer from the rotary body 5 to the second dispensing transport unit 23; and for transfer from the second dispensing transport unit 23 to the production devices 8c and 8d. By means of corresponding control of the valves 42 and/or 43 by the control device 20 (see FIG. 1), a segment 16 fed by the feed device 2 can be fed in a simple manner to one of the production devices 8a to 8d in a targeted manner. The rotational speed of the first and second dispensing transport units 21 and 23 and of the rotary body 5 of the transfer device 4 can be kept constant. It is also not necessary to change the rotational movement of the receiving transport unit 11 for control or regulation purposes.

### LIST OF REFERENCE SIGNS

1 Device
2 Feed device
3 Discharge device
4 Transfer device
5 Rotating body
6 Ejection station
7 Negative pressure sector
8 Production device
9 Cutting device
10 Magazine drum
11 Receiving transport unit
12 Dispensing device
13 Magazine
14 Holding device
15 Stack
16 Segment
17 Engagement openings
18 Negative pressure sector
19 Reject reservoir
20 Control device
21 Dispensing transport unit (first)
22 Detection device
23 Dispensing transport unit (second)
24 Negative pressure-free sector
25 Ejection drum
26 Reject reservoir
27 Scraping part
28 Scraping wall
29 Slots
30 Continuous web
31 Continuous web
32 Vacuum reservoir
33 Continuous conveyor device
34 Workpiece carrier
35 Holder
36 Removal device
37 Feed device
38 Second cutting device
39 Rotating body
40 Transfer area
41 Negative pressure device
42 Valve
43 Valve
44 Vacuum lines
45 Compressed air device
46 Compressed air line
47 Vacuum reservoir
48 Transport surface
49 Transport surface
50 Parallel guide
I Transfer point
II Transfer point
R Rotation direction
R′ Rotation direction

1. A device for the energy cell manufacturing industry, comprising:
a feed device that is adapted to feed segments, wherein
the device comprises at least two production devices arranged parallel to each other in a production flow, which are each adapted to perform a production step on, or with, a fed segment, and
at least one discharge device that is adapted to remove the segments from the production devices, wherein
the segments are transferred from the feed device to the production devices by means of a transfer device, and wherein
the device can be controlled and/or regulated by means of a control signal from a control device in such a way that a segment taken over from the feed device is transferred by the transfer device in a targeted manner to a specific production device of the at least two production devices.

2. The device according to claim 1, wherein
the device can be controlled and/or regulated by the control signal of the control device in such a way that a segment taken over by the feed device can be transferred to any production device of the existing production devices.

3. The device according to claim 1, wherein
the feed device comprises a single conveyor path for the segments, on which the segments are fed to the transfer device.

4. The device according to claim 1, wherein
the production devices are each formed by a stacking station, wherein
the stacking stations are each adapted to receive segments and to stack them on top of each other.

5. The device according to claim 1, wherein
the control device controls and/or regulates the device in such a way that alternately exactly one of the at least two production devices is the target for a segment.

6. The device according to claim 5, wherein
the control device controls and/or regulates the device in such a way that the existing production devices are supplied alternately with a predefined number of segments.

7. The device according to claim 6, wherein
the device is controlled and/or regulated by means of the control device in such a way that the production devices are supplied with segments in several passes, wherein
in one pass, each of the existing production devices is supplied with exactly one segment.

8. The device according to claim 1, wherein
the transfer device comprises at least one dispensing transport unit with at least one holding device for exerting a holding force on the segment in the production flow, wherein
the production devices each comprise a receiving transport unit with at least one holding device for exerting a holding force on the segment in the production flow, wherein
by adjusting the holding forces on the dispensing and/or receiving transport units by means of a control signal generated by the control device, a segment is transferred in a targeted manner to one of the production devices.

9. The device according to claim 8, wherein
the dispensing and receiving transport units each comprise at least one rotatably driven rotary body, wherein
the dispensing and receiving transport units each comprise at least one negative pressure sector that can be subjected to negative pressure in order to hold and transport a segment by means of negative pressure on a transport surface of the respective transport unit, wherein
the device can be controlled and/or regulated in such a way that, as a result of a control signal from the control device for transferring the segment, a higher holding force is generated on the receiving transport unit relative to the dispensing transport unit at least in a transfer area between the dispensing and receiving transport units.

10. The device according to claim 9, wherein
to reduce the holding force in a section of the transport surface of the dispensing transport unit, at least one valve switchable in a negative pressure device is arranged, wherein
the at least one switchable valve can be switched by means of a control signal from the control device in such a way that the holding force acting on a segment on the transport surface of the dispensing transport unit is reduced.

11. The device according to claim 1, wherein
a switchable compressed air device is provided for conducting compressed air to a dispensing point of the dispensing transport unit and/or to a receiving point of the receiving transport unit, wherein
the compressed air device can be switched by means of a control signal from the control device.

12. The device according to claim 1, wherein
the existing production devices comprise an identical structure and/or are adapted to perform an identical production step on or with a segment.

13. The device according to claim 1, wherein
an ejection station is provided that is adapted to eject segments from the production flow.

14. A method for performing a production step on or with a segment for the energy cell manufacturing industry, wherein
the method is carried out using the device according to claim 1.

15. The method according to claim 14, wherein
segments in the form of mono cells are stacked on top of each other in the production devices, wherein
the mono cells each comprise two separator sheets, an anode sheet and a cathode sheet.

16. The method according to claim 15, wherein
a first type of segments in the form of mono cells is fed by means of the feed device, and
a second type of segments, which differs from the first type of segments, is additionally fed by means of the feed device, wherein
a segment of the second type taken over by the feed device is transferred by the transfer device in a targeted manner to a specific production device of the at least two production devices in such a way that the segment of the second type forms the first or last layer of the stack of segments formed by the respective production device.

17. The device according to claim 6, wherein the predefined number of segments is exactly one segment.

18. The device according to claim 9, comprising a rotatably driven rotary body that is in the form of a dispensing drum.

19. The device according to claim 11, wherein the switchable compressed air device is switchable by means of a valve.
